(19) United States
(12) Patent Application Publication
(10) Pub. No.: US 2013/0115924 A1
(43) Pub. Date: May 9, 2013

(54) SYSTEM AND METHOD FOR COMBINED PASSIVE AND ACTIVE INTERCEPTION OF MOBILE COMMUNICATION

(71) Applicants: Yossi Nelkenbaum, Ramat - Gan (IL); Amir Barel, Hod Ha'Sharon (IL)

(72) Inventors: Yossi Nelkenbaum, Ramat - Gan (IL); Amir Barel, Hod Ha'Sharon (IL)

(73) Assignee: VERINT SYSTEMS LTD., Herzelia (IL)

(21) Appl. No.: 13/457,377

(22) Filed: Apr. 26, 2012

(30) Foreign Application Priority Data
Apr. 28, 2011 (IL) 212577

(51) Int. Cl. H04W 12/02

(52) U.S. Cl. CPC H04W 12/02
USPC 455/414.1

(57) ABSTRACT

A hybrid interception system that comprises both a passive interception subsystem and an active interception subsystem that operate jointly to intercept communication of a target wireless terminal. A passive interception system receives the communication without transmitting to the mobile communication terminal. An active interception system intercepts the communication by initiating temporary bidirectional communication with the terminal. The target terminal may be initially detected by the passive interception subsystem, while in other embodiments it is detected by the active interception subsystem. The subsystem that detects the target terminal triggers the other subsystem, so that the target terminal is effectively intercepted jointly by both subsystems. The outputs of both the passive and the active interception are analyzed jointly, stored in a joint data structure, and/or presented jointly to an operator. This joint analysis and presentation increases the quality and intelligence value of the intercepted information.

### FIELD OF THE DISCLOSURE

The present disclosure relates generally to communication interception, and particularly to methods and systems for joint passive and active interception.

### BACKGROUND OF THE DISCLOSURE

Communication interception is used in a variety of applications, such as for intelligence and surveillance, tracking locations of communication terminal users, or communication monitoring in restricted environments such as prisons.

### SUMMARY OF THE DISCLOSURE

Embodiments of the present invention provide apparatus, including a passive interception subsystem, which is configured to receive communication of wireless terminals in a wireless communication network without transmitting to the wireless terminals. An active interception subsystem is configured to intercept communication of the wireless terminals by initiating temporary bidirectional communication with the wireless terminals. The passive and active interception subsystems are configured to jointly intercept the communication of a target wireless terminal by operating in coordination with one another on the target wireless terminal.

In some embodiments, the passive interception subsystem is configured to detect the target wireless terminal and to trigger the active interception subsystem to initiate the bidirectional communication with the identified target wireless terminal. The passive interception subsystem may be configured to extract a Temporary Mobile Subscriber Identity (TMSI) of the target wireless terminal and to trigger the active interception subsystem with the extracted TMSI, wherein the active interception subsystem is configured to extract an International Mobile Subscriber Identity (IMSI) of the target wireless terminal that matches the TMSI.

In other embodiments, the active interception subsystem is configured to detect the target wireless terminal while the target wireless terminal is in an idle mode, and to cause the passive interception subsystem to receive the target wireless terminal. The active interception subsystem may be configured to instruct the passive interception subsystem to receive the target wireless terminal upon detecting the target wireless terminal. Additionally or alternatively, the active interception subsystem may be configured to solicit the target wireless terminal in the idle mode to register with the active interception subsystem, and thereafter to determine a Temporary Mobile Subscriber Identity (TMSI) and an International Mobile Subscriber Identity (IMSI) of the target wireless terminal, so as to enable the passive interception subsystem to identify the target wireless terminal to be intercepted.

In a disclosed embodiment, the active and passive interception subsystems are configured to extract respective first and second information from the communication of the target wireless terminal, and to store the first and second information in a single data structure. The first or second information may include at least one data type selected from a group of types consisting of media content that is extracted from the communication, an identifier of the target wireless terminal, and a geographical location of the target wireless terminal. Additionally or alternatively, the active and passive interception subsystems may be configured to extract respective first and second information from the communication of the target wireless terminal, and to present the first and second information to an operator in a joint Man Machine Interface (MMI).

There is also provided, in accordance with an embodiment of the present invention, a method, which includes, using a passive interception subsystem, receiving communication of wireless terminals in a wireless communication network without transmitting to the wireless terminals. Using an active interception subsystem, communication of the wireless terminals is intercepted by initiating temporary bidirectional communication with the wireless terminals. The communication of a target wireless terminal is intercepted by operating on the target wireless terminal jointly using the passive and active interception subsystems in coordination with one another.

There is additionally provided, in accordance with an embodiment of the present invention, a computer software product for use in a system that includes a passive interception subsystem, which receives communication of wireless terminals in a wireless communication network without transmitting to the wireless terminals, and an active interception subsystem, which intercepts communication of the wireless terminals by initiating temporary bidirectional communication with the wireless terminals, the product including a tangible non-transitory computer-readable medium, in which program instructions are stored, which instructions, when read by a computer, cause the computer to operate the passive and active interception subsystems so as to jointly intercept the communication of a target wireless terminal by operating in coordination with one another on the target wireless terminal.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a hybrid passive/active communication interception system, in accordance with an embodiment that is described herein; and

FIGS. 2-4 are flow charts that schematically illustrate methods for combined passive/active communication interception, in accordance with embodiments that are described herein.

### DETAILED DESCRIPTION OF EMBODIMENTS

### Overview

Communication of a mobile communication terminal in a wireless communication network, e.g., communication between a cellular phone and a base station, can be intercepted using either passive or active interception systems. A passive interception system receives the communication without transmitting to the mobile communication terminal. An active interception system intercepts the communication by initiating temporary bidirectional communication with the terminal.

Passive and active interception systems have different characteristics that may complement one another, and each type of system may be preferable in a different scenario. For example, passive interception schemes have the advantage of being undetectable, unlike active interception that can potentially be detected by the intercepted party. On the other hand, passive interception can operate only on existing network events (e.g., phone calls or location updates of terminals), whereas active interception can initiate network events. As such, active interception systems are able to intercept idle terminals, while passive interception systems are usually unaware of such terminals.

As another example, active interception systems are typically able to intercept a relatively small number of terminals at a given time, whereas passive interception systems usually have high interception capacity. Active interception systems can only intercept a call from its beginning, while passive interception systems can typically start intercepting a call at any stage. As yet another example, in some wireless network types, passive interception is able to obtain only a Temporary Mobile Subscriber Identity (TMSI) of the intercepted terminal, which is usually of little value because it is not uniquely correlated to the terminal user. Active interception is able to extract an International Mobile Subscriber Identity (IMSI) of the terminal, which is fixed and highly correlative with the identity of the user and to correlate it with the Temporary Mobile Subscriber Identity (TMSI).

Embodiments that are described herein provide improved methods and systems for interception, which combine passive and active interception. The disclosed techniques take advantage of the differing characteristics of passive and active interception, and combine them in ways that complement one another.

In a typical embodiment, a hybrid interception system comprises both a passive interception subsystem and an active interception subsystem that operate jointly to intercept communication of a target wireless terminal. In some embodiments the target terminal is initially detected by the passive interception subsystem, while in other embodiments it is detected by the active interception subsystem. The subsystem that detects the target terminal triggers the other subsystem, so that the target terminal is effectively intercepted jointly by both subsystems. Several example interception flows are described hereinbelow.

The hybrid passive/active interception schemes described herein achieve overall interception performance that surpasses the performance of either passive or active interception alone. Typically, the disclosed schemes can achieve a level of stealth and capacity that is comparable with that of passive interception, while at the same time successfully intercepting idle terminals and extracting valuable terminal attributes.

In some disclosed embodiments, the outputs of both the passive and the active interception are analyzed jointly, stored in a joint data structure, and/or presented jointly to an operator. This joint analysis and presentation increases the quality and intelligence value of the intercepted information.

### System Description

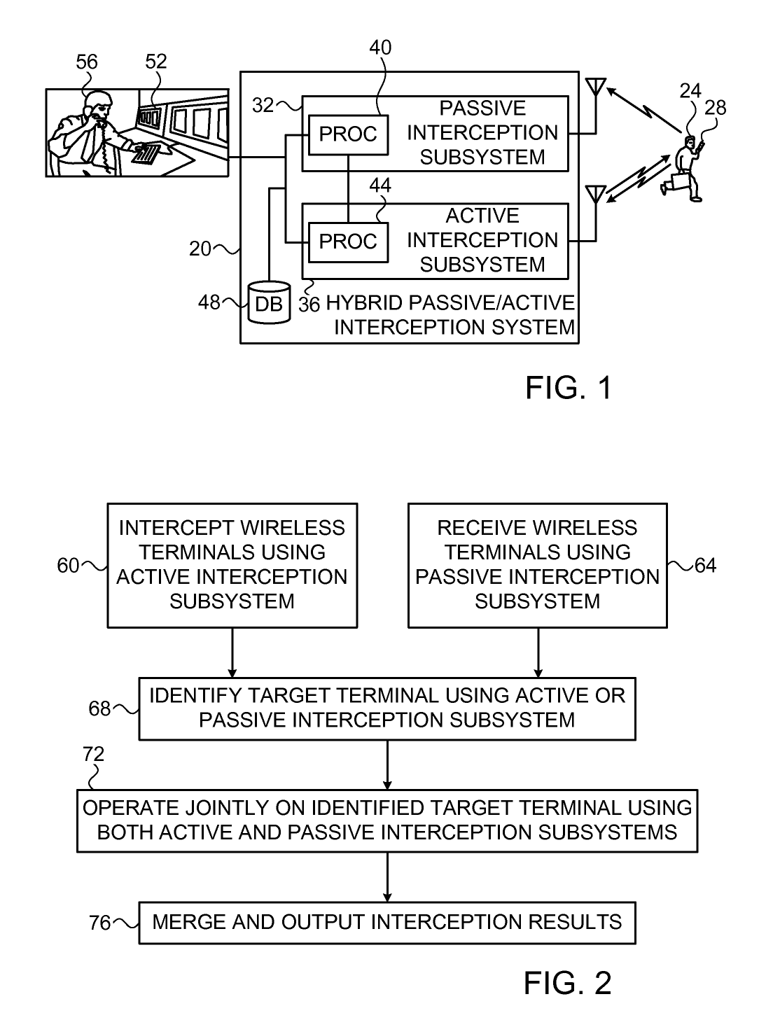

FIG. 1 is a block diagram that schematically illustrates a hybrid passive/active communication interception system 20, in accordance with an embodiment that is described herein. System 20 intercepts communication conducted by users 24 who operate wireless communication terminals 28. Systems of this sort may be used, for example, by government and law enforcement agencies for intelligence gathering and surveillance, for monitoring communication in restricted environments such as prisons, or in any other suitable application. Terminals 28 communicate over a wireless communication network, e.g., a cellular network. The wireless network may comprise, for example, a Global System for Mobile communications (GSM) or Universal Mobile Telecommunications Service (UMTS) network, a Wireless Local Area Network (WLAN), or any other suitable network type. Although the embodiments described herein address a single wireless network, in alternative embodiment system 20 may intercept communication of wireless terminals belonging to multiple wireless networks, as well.

Terminals 28 may comprise, for example, cellular phones, mobile computing devices equipped with wireless modems, or any other suitable type of device capable of wireless communication. The communication intercepted by system 20 may involve transfer of voice, data, images or any other suitable media type. The system may intercept uplink communication transmitted from the terminals to the network, downlink communication transmitted from the network to the terminals, or both.

System 20 is typically used for tracking target users, e.g., users 24 who are suspected of being involved in illegitimate activities or users who are of interest for any other reason. Nevertheless, in some applications system 20 can be used for indiscriminate tracking of users, e.g., users located in a certain geographical area. In this context, any user 24 who is tracked by the system can be referred to as a target user.

System 20 comprises a passive interception subsystem 32 and an active interception subsystem 36, and operates the two types of subsystems jointly to track target terminals. Several examples of joint interception schemes are described below.

Passive interception subsystem 32 intercepts communication of terminals 28 passively, i.e., without transmitting to the wireless terminals or otherwise affecting the operation of the wireless network. In the present example, passive subsystem 32 receives Radio Frequency (RF) signals from terminals 28 or from the base stations of the wireless network with which the terminals communicate.

Active interception subsystem 36 intercepts communication of terminals 28 actively, by initiating temporary bidirectional communication with the intercepted terminals. In some embodiments, active subsystem 36 masquerades as a legitimate base station of the wireless network, and solicits terminals 28 to establish communication. For example, active subsystem 36 may transmit a downlink signal that is strong relative to the signals of legitimate base stations, thereby causing terminals 36 to initiate communication with subsystem 36.

Using this initial bidirectional communication with a terminal, active subsystem 36 extracts attributes of the solicited terminal, such as the terminal's IMSI and TMSI. After extracting the desired attributes, active subsystem 36 typically rejects the terminal and the terminal thus returns to communicate with the wireless network. Such techniques are therefore sometimes referred to as “IMSI catching.” Examples of IMSI catching techniques are described, for example, by Strobel in “IMSI Catcher,” Jul. 13, 2007, which is incorporated herein by reference.

In the embodiment of FIG. 1, passive interception subsystem 32 comprises a processor 40 that controls the passive subsystem, and active interception subsystem 36 comprises a processor 44 that controls the active subsystem. In the description that follows, although not necessarily, the disclosed techniques are carried out jointly by the two processors. In some embodiments, system 20 further comprises a database (DB) 48 for storing interception communication content, terminal attributes or any other suitable information.

Passive interception subsystem 32 and active interception subsystem 36 of system 20 operate in coordination to intercept communication of target wireless terminals, as will be explained in detail below. System 20 outputs the intercepted information to a monitoring center 52 for presenting to an operator 56. The monitoring center comprises suitable output devices for presenting the intercepted information to the operator, and suitable input devices using which the operator controls system 20.

The configuration of system 20 shown in FIG. 1 is an example configuration, which is shown purely for the sake of clarity. In alternative embodiments, any other suitable configuration can also be used. For example, although FIG. 1 shows a single passive interception subsystem and a single active interception subsystem, in alternative embodiments the system may comprise multiple passive interception subsystems and/or multiple active interception subsystems. In n example embodiment, system 20 may comprise a single passive subsystem and multiple active subsystems, in order to match the interception capacities of the two subsystem types.

As another example, in the present example the disclosed techniques are carried out jointly by processors 40 and 44. Alternatively, the disclosed techniques can be carried out by processor 40 alone, by processor 44 alone, or by a third dedicated processor (not shown). Generally, any suitable partitioning of functions among the elements of system 20 can be used.

The elements of system 20 may be implemented using hardware, e.g., using one or more Application-Specific Integrated Circuits (ASICs) or Field-Programmable Gate Arrays (FPGAs), using software, or using a combination of hardware and software elements. DB 48 may comprise any suitable type of storage device such as magnetic or solid state memory.

In some embodiments, processors 40 and 44 (or other processor that carries out the joint interception schemes described herein) comprise general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Example Passive/Active Interception Schemes

System 20 may carry out joint passive/active interception in various ways. Typically, the disclosed techniques exploit the differing characteristics of the passive and active interception modalities, so as to complement one another and achieve improved overall system performance.

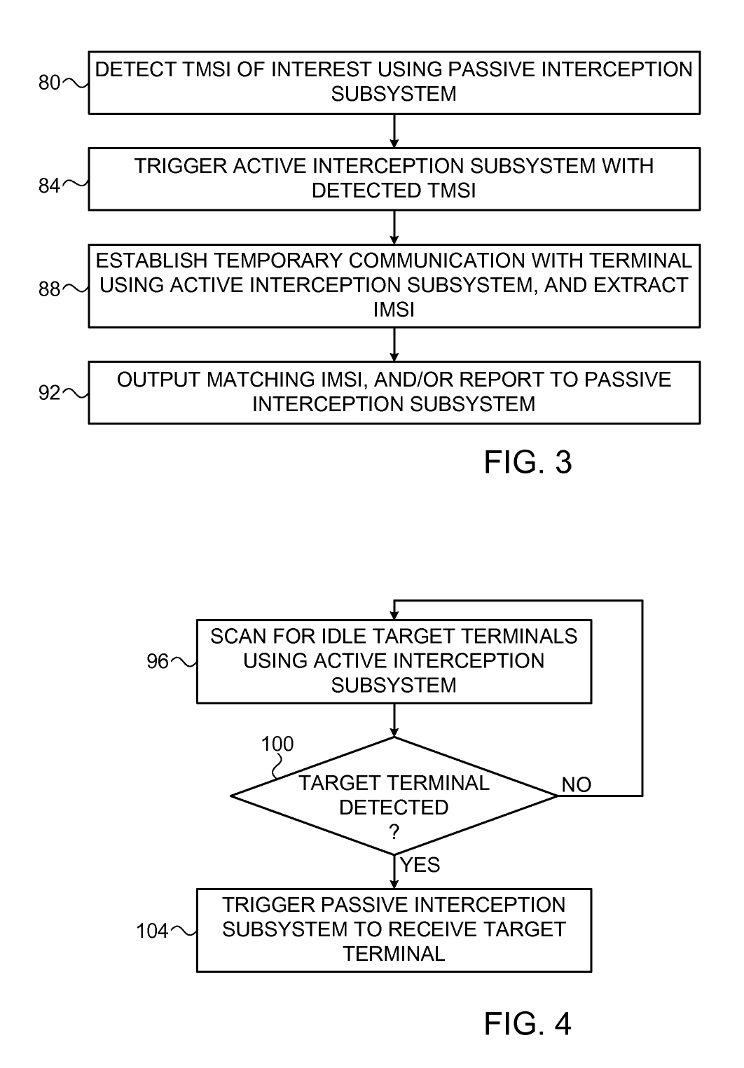

FIG. 2 is a flow chart that schematically illustrates a method for combined passive/active communication interception, in accordance with an embodiment that is described herein. The method begins with active interception subsystem 36 intercepting wireless terminals 28, at an active interception step 60, and with passive interception subsystem 32 receiving the wireless terminals' communication, at a passive interception step 64. In various embodiments, examples of which are described below, step 60 may be performed before, after or concurrently with step 64.

System 20 identifies a terminal that is potentially a target for surveillance, at a target terminal identification step 68. The target terminal may be detected either by active interception subsystem 36 or by passive interception subsystem 32. FIG. 3 below shows an example technique in which the target terminal is detected by the passive interception subsystem. FIG. 4 below shows an example technique in which the target terminal is detected by the active interception subsystem.

The passive and active interception subsystems operate jointly on the detected target terminal, at a joint interception step 72. Each of the interception subsystems obtains certain interception results relating to the target terminal, e.g., identifiers of the target terminals (e.g., TMSI or IMSI), media content extracted from the intercepted communication (e.g., voice, data or images), a geographical location of the target terminal, or any other suitable interception results. System 20 merges the interception results obtained by the passive and active interception subsystems, at a result merging step 76. The merged results are then provided to monitoring center 52 for presenting to operator 56. In some embodiments the merged results are stored in a single data structure in DB 48.

FIGS. 3 and 4 below describe examples of specific interception methods in which the active and passive interception subsystems operate jointly on a target terminal. These methods, however, are provided purely by way of example. In alternative embodiments, any other suitable method can also be used.

FIG. 3 is a flow chart that schematically illustrates a method for combined passive/active communication interception, in accordance with an embodiment that is described herein. The method begins with passive interception subsystem 32 detecting s target terminal, at a passive detection step 80. In the present example, the passive interception subsystem is only able to extract the TMSI of the target terminal. The TMSI is allocated temporarily to the terminal by the network, and is therefore not uniquely associated with the terminal or with its user. As such, the TMSI by itself typically has little intelligence value.

In the method of FIG. 3, system 20 invokes the active interception subsystem to intercept the same target terminal that was detected by the passive interception subsystem. The active interception subsystem is able to extract the target terminal's IMSI, which is uniquely associated with the terminal, and therefore has high intelligence value.

Passive interception subsystem 32 triggers active interception subsystem 36 with the detected TMSI, at an active triggering step 84. In response to the trigger, active interception subsystem 36 establishes temporary bidirectional communication with the terminal in question, at an active communication step 88. By communicating with the target terminal, the active interception subsystem extracts the IMSI of the terminal.

At this stage, the active interception subsystem has both the TMSI and the IMSI of the target terminal that was initially detected by the passive interception subsystem. The active interception subsystem outputs the matching IMSI to monitoring center 52, at an output step 92. Additionally or alternatively, the active interception subsystem may report the matching IMSI to the passive interception subsystem, so that the passive subsystem has the association between the terminal's TMSI and IMSI. The IMSI and TMSI may be stored in DB 48 and/or provided to the monitoring center together with any other suitable interception results relating to the target terminal.

FIG. 4 is a flow chart that schematically illustrates a method for combined passive/active communication interception, in accordance with an embodiment that is described herein. In this method, unlike the method of FIG. 3 above, the target terminal is initially detected by the active interception subsystem. This method is particularly effective for intercepting terminals that are in an idle mode. These terminals are typically undetectable by the passive interception subsystem.

The method begins with active interception subsystem 36 scanning to find idle target terminals, at a scanning step 96. In this example, the active interception subsystem holds a predefined list of target terminals, e.g., a list of target IMSIs. The active interception subsystem checks whether any of the terminals that are solicited into establishing communication belongs to the list, at a target checking step 100. If one of the solicited terminals is a target terminal, the active interception subsystem sends a trigger that instructs the passive interception subsystem to receive this terminal, at a passive triggering step 104.

In some embodiments, it is not necessary for the active interception subsystem to explicit instruct the passive interception subsystem to track the detected target terminal. Typically, the communication initiated by the active interception subsystem with the target terminal causes the terminal to exit the idle mode, and transmit or otherwise generate a network event. In some embodiments, the passive interception subsystem is able to intercept this event without receiving an explicit trigger from the active interception subsystem.

In some embodiments, the passive and active interception subsystems store their respective interception results relating to a given target terminal in a single data structure in DB 48. The jointly-stored results can be jointly indexed, browsed, searched, analyzed or otherwise processed or accessed by operator 56. In some embodiments, the passive and active interception subsystems present their respective interception results relating to the target terminal to operator 56 using a joint Man Machine Interface (MMI). This sort of joint storage, analysis and presentation is applied to information that is not available to the passive or active subsystem individually. As such, the joint storage, analysis and presentation provide considerable analytics and intelligence value that is not achievable using passive or active interception alone.

In alternative embodiments, the passive and active interception subsystems may operate in coordination with one another on the same target terminal in any other suitable way.

It will thus be appreciated that the embodiments described above are cited by way of example, and that the present disclosure is not limited to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. Apparatus, comprising:
a passive interception subsystem, which is configured to receive communication of wireless terminals in a wireless communication network without transmitting to the wireless terminals; and
an active interception subsystem, which is configured to intercept communication of the wireless terminals by initiating temporary bidirectional communication with the wireless terminals,
wherein the passive and active interception subsystems are configured to jointly intercept the communication of a target wireless terminal by operating in coordination with one another on the target wireless terminal.

2. The apparatus according to claim 1, wherein the passive interception subsystem is configured to detect the target wireless terminal and to trigger the active interception subsystem to initiate the bidirectional communication with the identified target wireless terminal.

3. The apparatus according to claim 2, wherein the passive interception subsystem is configured to extract a Temporary Mobile Subscriber Identity (TMSI) of the target wireless terminal and to trigger the active interception subsystem with the extracted TMSI, and wherein the active interception subsystem is configured to extract an International Mobile Subscriber Identity (IMSI) of the target wireless terminal that matches the TMSI.

4. The apparatus according to claim 1, wherein the active interception subsystem is configured to detect the target wireless terminal while the target wireless terminal is in an idle mode, and to cause the passive interception subsystem to receive the target wireless terminal.

5. The apparatus according to claim 4, wherein the active interception subsystem is configured to instruct the passive interception subsystem to receive the target wireless terminal upon detecting the target wireless terminal.

6. The apparatus according to claim 4, wherein the active interception subsystem is configured to solicit the target wireless terminal in the idle mode to register with the active interception subsystem, and thereafter to determine a Temporary Mobile Subscriber Identity (TMSI) and an International Mobile Subscriber Identity (IMSI) of the target wireless terminal, so as to enable the passive interception subsystem to identify the target wireless terminal to be intercepted.

7. The apparatus according to claim 1, wherein the active and passive interception subsystems are configured to extract respective first and second information from the communication of the target wireless terminal, and to store the first and second information in a single data structure.

8. The apparatus according to claim 7, wherein the first or second information comprises at least one data type selected from a group of types consisting of media content that is extracted from the communication, an identifier of the target wireless terminal, and a geographical location of the target wireless terminal.

9. The apparatus according to claim 1, wherein the active and passive interception subsystems are configured to extract respective first and second information from the communication of the target wireless terminal, and to present the first and second information to an operator in a joint Man Machine Interface (MMI).

10. A method, comprising:
using a passive interception subsystem, receiving communication of wireless terminals in a wireless communication network without transmitting to the wireless terminals;
using an active interception subsystem, intercepting communication of the wireless terminals by initiating temporary bidirectional communication with the wireless terminals; and
intercepting the communication of a target wireless terminal, by operating on the target wireless terminal jointly using the passive and active interception subsystems in coordination with one another.

11. The method according to claim 10, wherein intercepting the communication comprises detecting the target wireless terminal using the passive interception subsystem, and triggering the active interception subsystem to initiate the bidirectional communication with the identified target wireless terminal.

12. The method according to claim 11, wherein detecting the target wireless terminal comprises extracting a Temporary Mobile Subscriber Identity (TMSI) of the target wireless terminal using the passive interception subsystem, wherein triggering the active interception subsystem comprises providing the active interception subsystem with the extracted TMSI, and comprising extracting, using the active interception subsystem, an International Mobile Subscriber Identity (IMSI) of the target wireless terminal that matches the TMSI.

13. The method according to claim 10, wherein intercepting the communication comprises detecting the target wireless terminal using the active interception subsystem while the target wireless terminal is in an idle mode, and causing the passive interception subsystem to receive the target wireless terminal.

14. The method according to claim 13, wherein causing the passive interception subsystem to receive the target wireless terminal comprises instructing the passive interception subsystem by the active communication subsystem to receive the target wireless terminal upon detecting the target wireless terminal.

15. The method according to claim 13, wherein causing the passive interception subsystem to receive the target wireless terminal comprises causing the wireless terminal to exit the idle mode by initiating the bidirectional communication, so as to enable the passive interception subsystem to receive the target wireless terminal.

16. The method according to claim 10, wherein intercepting the communication comprises extracting from the communication of the target wireless terminal first and second information using the active and passive interception subsystems, respectively, and storing the first and second information in a single data structure.

17. The method according to claim 16, wherein the first or second information comprises at least one data type selected from a group of types consisting of media content that is extracted from the communication, an identifier of the target wireless terminal, and a geographical location of the target wireless terminal.

18. The method according to claim 10, wherein intercepting the communication comprises extracting from the communication of the target wireless terminal first and second information using the active and passive interception subsystems, respectively, and presenting the first and second information to an operator in a joint Man Machine Interface (MMI).

19. A computer software product for use in a system that includes a passive interception subsystem, which receives communication of wireless terminals in a wireless communication network without transmitting to the wireless terminals, and an active interception subsystem, which intercepts communication of the wireless terminals by initiating temporary bidirectional communication with the wireless terminals, the product comprising a tangible non-transitory computer-readable medium, in which program instructions are stored, which instructions, when read by a computer, cause the computer to operate the passive and active interception subsystems so as to jointly intercept the communication of a target wireless terminal by operating in coordination with one another on the target wireless terminal.
